(19) United States
(12) Patent Application Publication
(10) Pub. No.: US 2004/0008622 A1
(43) Pub. Date: Jan. 15, 2004

(54) Lightpath visualization method for mesh WDM networks

(76) Inventors: Jean Dolbec, Ottawa (CA); Robert Gaudet, Ottawa (CA); Kirby Koster, Almonte (CA); Mei-Chun Jenny Leung, Ottawa (CA)

Correspondence Address: MARKS & CLERK, P.O. BOX 957, STATION B, OTTAWA, ON, K1P 5S7, CA

(21) Appl. No.: 10/603,690

(22) Filed: Jun. 26, 2003

Related U.S. Application Data
(60) Provisional application No. 60/391,406, filed on Jun. 26, 2002.

(51) Int. Cl. H04L 1/00

(52) U.S. Cl. 370/223; 370/216

(57) ABSTRACT

The invention creates a capability within the network management software application to highlight the path through the network for a selected lightpath. The user first selects a lightpath and then turns on the highlighted function. When highlighting is on the user can navigate through the network manager and visualize the lightpath shown by different colours for example dark blue for working and light blue for protection. At the network level, this enable the operator to see the routing of the path.

This application claims the benefit of U.S. Provisional Application No. 60/391,406 filed Jun. 26, 2002.

### FIELD OF THE INVENTION

This invention relates to network management of telecommunications networks and more particularly to a method and system for displaying and visualizing lightpaths in a mesh wavelength division multiplexed (WDM) network.

### BACKGROUND

Network operators are starting to deploy mesh WDM networks whereby multiple wavelengths can be connected in order to provide an end to end lightpath through the network. Network management tools give the operator the ability to visualize the network (i.e. network elements connected by fiber optic cables) but do not have the ability to visualize the network routing and physical cards used by a lightpath. Without this visualization, network maintenance activities and trouble shooting are very difficult and error-prone.

WDM systems of today are typically either ring-based or point-to-point systems, which support a very limited number of network configurations, whereas the new emerging mesh-network WDM systems support an extensive variety and number of network configurations. The more potential routing options through a network the greater the need for visualization by an operator. For example, ring-based systems follow a strict protection strategy whereby wavelengths are necessarily protected in the opposite direction of the ring. Further, wavelength translation never takes place meaning that a circuit using a particular wavelength (eg. wavelength 1) in a ring, will only ever use the same wavelength (eg. wavelength 1) and never get switched to another wavelength. This means that if a lightpath is configured through a ring, the operator does not need visualization ability to understand the route of the path, the equipment used, and the wavelength allocation (see FIG. 1).

New mesh WDM networks with multiplexors and switches allow much more complicated lightpath configurations and routing. Lightpaths can travel many different routes through the network, wavelengths can be translated by switching functions, and protection schemes are much more flexible than the ring configuration. Lightpaths can follow arbitrary routes and have arbitrary protection schemes. In FIG. 2, a lightpath is configured through a mesh network using different wavelengths and different routing for the working and protection portions of the path.

Current network management solutions do not enable the operator to visualize the route of the path, both working and protection, or the wavelength usage for each hop of the path.

### SUMMARY OF THE INVENTION

It is an object of the present invention to provide a system and method of highlighting the working path through the network for a selected lightpath. The highlighting can also be extended to a protection path.

This invention creates a capability within the network management software application to highlight the path through the network for a selected lightpath. The user will first select a lightpath and then turn on the highlighting function. When highlighting is on, the user can navigate through the network manager and visualize the lightpath, shown by different colors or other distinguishing means (for example, dark blue for working and light blue for protection) on a Graphical User Interface (GUI). At the network level, this enables the operator to see the routing of the path. When the user navigates to a specific fiber in the network, the system will also highlight the specific wavelength used in the path. When the user navigates to a specific network element, the equipment (eg. cards and ports) will be highlighted clearly identifying the equipment involved in this particular lightpath. Highlighting stays on until switched off by the user.

Therefore in accordance with a first aspect of the present invention there is provided a system for highlighting lightpaths in a mesh wavelength division multiplexed (WDM) network comprising: means to input in a user interface of a NMS, data respecting selected lightpath from a source to a destination in the network; and means to highlight the selected lightpath on the user interface.

In preferred embodiments of the invention the system also allows the highlighting of a protection path for the segment. Typically, the highlighting for the protection path will be different than the highlighting for the segment.

In accordance with a second aspect of the invention there is provided a method of highlighting a lightpath in a mesh WDM network comprising inputting information respecting a selected lightpath from a source to a destination in a network management application; and activating a highlight function in order to highlight the selected path on a graphical user interface.

### BRIEF DESCRIPTION OF THE DRAWINGS

The invention will now be described in greater detail with reference to the attached drawings wherein:

FIG. 1 illustrates a typical WDM ring network;

FIG. 2 shows a mesh WDM network with protection;

FIG. 3 is a flow chart of a GUI display algorithm;

FIG. 4 is a GUI displaying selected lightpath and highlighting button;

FIG. 5 is a GUI showing highlighted working path and protection path;

FIG. 6 is a GUI showing shelf view of cards and ports highlighted; and

FIG. 7 illustrates highlighting with segment protection.

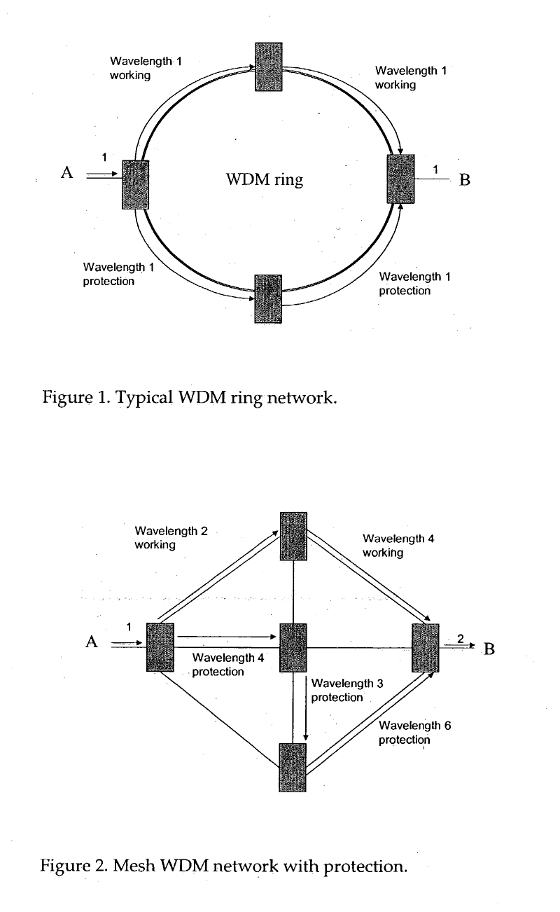

### DETAILED DESCRIPTION OF THE INVENTION

As discussed previously the present invention relates to methods and systems for permitting a user to visualize light path architectures for a mesh WDM network. The system user is able to visualize particular working paths and, if desired protection paths, if such have been provisioned in a mesh WDM communication network. Typically, such a network will have network nodes which include but are not limited to optical switches and optical multiplexers which cooperate to carry data between remote end points in the network. Conveniently, the data is carried on a working path which is set up and provisioned by the NMS. It is also within the scope of the present invention to set up an end to end protection path for the working path or if desired protection paths for specific segments of the working path may be set up. U.S. Provisional Application No. 60/391,404 filed Jun. 26, 2003 describes in greater detail the establishment of protection paths for segments, the contents of the provisional application are incorporated herein by reference.

The system of the present invention relies on an MMS such as a Meriton Network 8600 NMS. The NMS includes a graphical user interface (GUI) for selectively displaying information such as working paths, protection paths as well as network nodes. The NMS also has one or more input devices typically using point and click technology to enable the functionality supported by the NMS. This functionality includes but is not limited to light path highlighting and the listing of all provisioned lightpaths or lightpath segments.

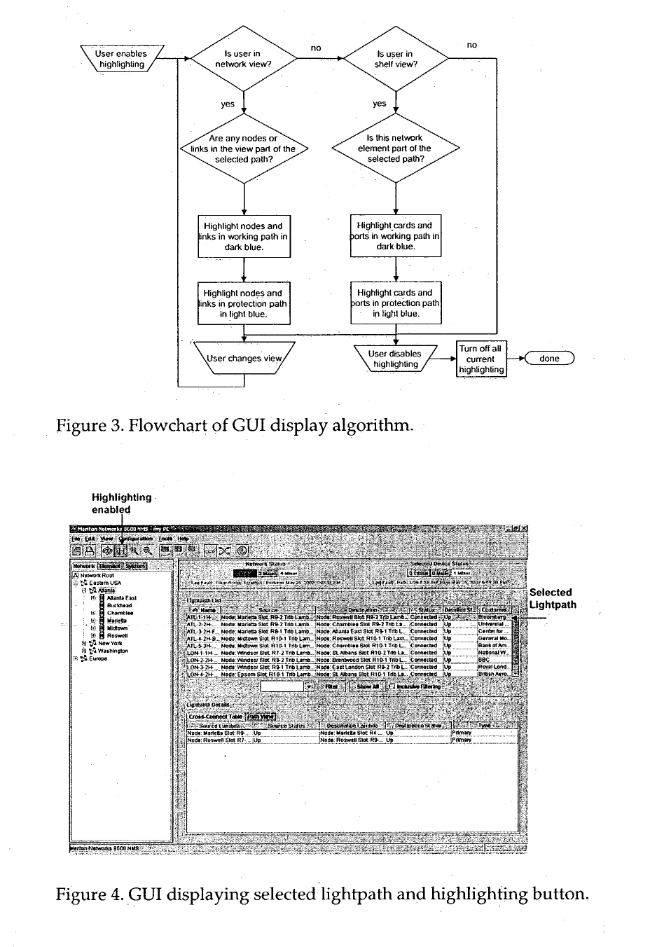

The visualizing approach of the present invention can be used in the basic system but will be more applicable to advanced network management approaches such as grouping and building of network hierarchies. In the more advanced network management the user is given the ability to drill in and drill out of network views in order to show more and less detail respectively. In these cases the current GUI representation is examined to determine if the currently selected lightpath is part of any entity to be displayed. If so that entity is highlighted using the present system. The highlighted entity can be a particular path or a particular network node within the path. FIG. 3 is a flow chart illustrating the algorithm followed in accordance with the display algorithm of the invention. As shown in FIG. 3 the user enables the highlighting feature on the network manager and the user is presented with a network view. If the user is in the network view the network mangement system determines whether any nodes or links in the view are part of the selected path. If they are, the nodes and links in the working path are highlighted in a distinguishable color for example dark blue. The function then will highlight any nodes and links which are protected by a protection path in a second distinguishing manner such as light blue color. Following this highlighting the user may choose to change views.

If the user is not in the network view a user is prompted to determine if the user is in a shelf or element. If not the user is prompted to change views. If yes the network management system determines whether the element is part of the selected path. If it is the cards and ports in the working path are highlighted in colors such as dark blue the cards and ports of the protection path are highlighted in color such as light blue. The user is then prompted to disable the highlighting whereby all current highlighting is turned off.

The 8600 also has the capability to present a list of all of the provisioned light paths in the system. The user can then select any path and turn on the highlighting feature. FIG. 4 shows a GUI displaying a selected lightpath as indicated by the selected lightpath arrow. The selected lightpath arrow can be scrolled through the list and the desired path highlighted using the highlight enabled button. See FIG. 4.

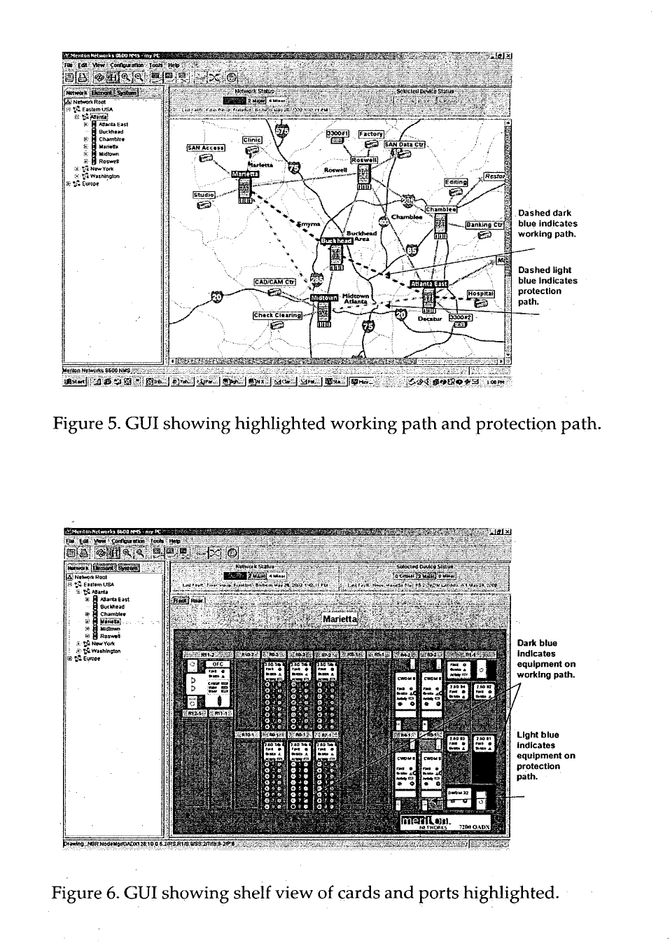

With highlighting enabled the user can navigate to a high level view of the network as shown in FIG. 5 which is a GUI representation of a working path and a protection path. The display in FIG. 5 illustrates on a representation of a map, network nodes at specific geographic locations and a working path highlighted in a particular color with a protection path illustrated in a second color.

If desired a user or operator can drill down into a finer granularity such as a particular fiber or network element to see what equipment is actually in use for a particular lightpath. FIG. 6 shows a GUI representation of a network element which is involved in the lightpath. It is to be understood that this is an example only and could show other elements in the network.

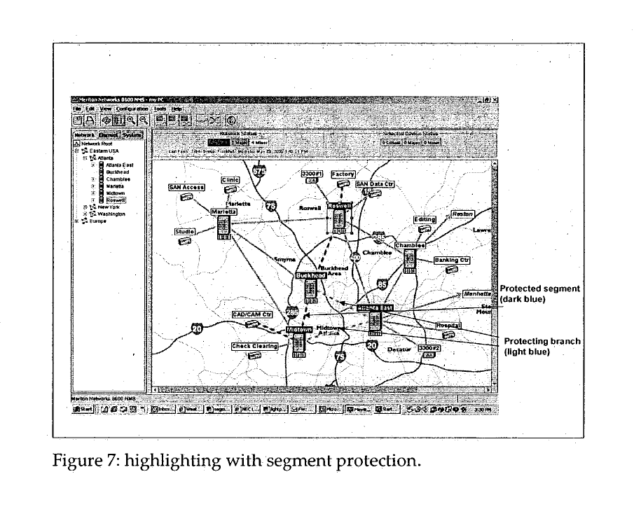

FIG. 7 depicts another form of protection being highlighted. In this case only a portion of the working light path is protected by a protecting branch. In accordance with the invention the highlighting function stays on until turned off by the user. Any time the user sees a highlighted path either dark blue or light blue it indicates that the equipment is part of the highlighted light path.

Although specific embodiments of the invention have been illustrated and described it will be apparent to one skilled in the art that numerous changes can be made without departing from the basic concept. It is to be understood, however, that such changes will fall within the full scope of the invention as defined by the appended claims.

1. A system for highlighting lightpaths in a mesh wavelength (WDM) network comprising: means to input via a user interface a selected lightpath from a source to a destination in the network, and means to highlight said selected lightpath on a display of said user interface.

2. The system as defined in claim 1 wherein said means to input allows an operator to designate a protection path for said lightpath.

3. The system as defined in claim 2 wherein said means to highlight allows highlighting of the protection path.

4. The system as defined in claim 3 wherein said highlighting for said selected lightpath is different then said highlighting for said protective path.

5. The system as defined in claim 1 wherein said means to highlight includes a point and click input device.

6. The system as defined in claim 1 wherein said means to input allows an operator to drill-in to display on a finer scale network nodes in the selected lightpath.

7. The system as defined in claim 2 wherein said protection path includes a protection path from said source to said destination.

8. The system as defined in claim 2 wherein said protection path includes a protection path for lightpath segments making up the lightpath.

9. The system as defined in claim 4 wherein different colors are used to distinguish between said selected lightpath and said protection path.

10. A method of highlighting a lightpath in a mesh WDM network comprising inputting a selected lightpath from a source to a destination in a network management application; and activating a highlight function in order to highlight the selected path on a graphical user interface.

11. The method as defined in claim 10 wherein said network management application provides a system user with input means to input user selections in response to options presented on GUI.

12. The method as defined in claim 11 wherein said GUI displays parameters respecting said selected lightpath.

13. The method as defined in claim 12 wherein said user is able to highlight a protection path for said selected path.

14. The method as defined in claim 13 wherein said options include drilling in on a segment path to view network nodes and shelf level details.

15. The method as defined in claim 13 wherein said selected path and said protection path are highlighted by different means.

16. The method as defined in claim 15 wherein said selected path and said protection path are highlighted by different colors on said GUI.
